(19) United States
(12) Patent Application Publication
(10) Pub. No.: US 2015/0135933 A1
(43) Pub. Date: May 21, 2015

(54) Rebound Multi-Rod Drumstick

(71) Applicant: David Chappell Rundle, Burlington (CA)

(72) Inventor: David Chappell Rundle, Burlington (CA)

(21) Appl. No.: 14/606,270

(22) Filed: Jan. 27, 2015

(51) Int. Cl. G10D 13/00

(52) U.S. Cl. CPC G10D 13/003
USPC 84/422.4

(57) ABSTRACT

A stick type drum stick is disclosed which includes a plurality of elongated reasonably straight wooden rods formed around a central dowel. The central dowel is comprised of a larger diameter sized wooden rod, the central dowel has two perpendicular slots cut into the horizontal plain starting at the end nearest to the playing or striking end. The plurality of rods having the same length as the central dowel are placed around the central dowel's outside diameter. A retaining sleeve is securely fitted over the gripping end creating a handle area. At the opposite end an additional retaining sleeve shorter in length is secured slightly back from the playing or striking end allowing some flexibility for the outer rods. The primary purpose of the slotted central dowel is to increase the rebound of the drum stick design. The result of combining these materials in this format produces the Rebound Multi-Rod Drumstick.

### BACKGROUND OF THE INVENTION

1. Field of Invention

The present invention relates to drumsticks and, more particularly, to a unique wooden stick type drumstick-with improved percussive characteristics.

2. Description of the Prior Art

In the prior art there have been three types of drumsticks. The brush type which typically produces a sweeping sound and the stick type which produce a much stronger or more percussive sound. In the prior, art stick type drumsticks were made of elongated round, generally cylindrical solid wood members that were tapered near one end. This end typically was in the shape of a ball-like head which was used to beat on the drum.

The brush type drumsticks were usually made up of a plurality of metal filaments secured to a handle. One improved embodiment of a brush type drumstick is shown in U.S. Pat. No. 4,200,026. That invention involves the use of a plurality of elongated plastic strands which are arranged in a tight bundle which is fixed at one end as by molding or fusing to form a handle. The plastic strands are free to spread out at the other end to achieve the brush sound when used. That drumstick, although an improvement over prior art brush sticks offers only limited use as a percussive stick owing to its basically soft and flexible nature.

In U.S. Pat No. 4,535,671, that patent provides certain unique playing characteristics suitable for certain applications. By means of this drumstick certain percussive resonance and tonal qualities are met. The drumstick of this invention includes a bundle, substantially straight wooden rods, which are preferably round hardwood rods such as dowels. The bundle is assembled and bound or banded tightly together, as by a rigid plastic tape. In this drumstick design, a band is placed at a location relatively close to the playing or striking end. The rods at the handle end of the bundle are also retained tightly together. A sleeve or overlay retainer may then be applied over the drumstick at the opposite end to form the handle. The combination of the binding of the rods as such yields a stick type drumstick, which has specific percussive strength, yet it is slightly flexible so that the combination including the interaction of the wooden rods among themselves when a drum is struck yields its tonal qualities.

A third drum stick design under U.S. Pat No. 7,084,339 is registered under this applicant's name. Its design utilizes a central foam core surrounded by multiple rods. These materials are held together in a round bundle using tape and shrink tubing. The playing characteristics include an increase bounce effect, the foam core aids in protecting the small outer rods at force of impact. It is with respect to this patent number that this application and stick design has further enhanced and altered the physical properties and playing characteristics inherent of that particular patent. Although similar in nature this invention combines a central dowel with slots at the playing end that allow the dowel to compress and expand adding a rebound to the drumstick's playing characteristics creating a unique Rebound Multi-Rod Drumstick warranting its own need for patent consideration.

### SUMMARY OF THE INVENTION

The drumstick of the present invention includes multiple rods of reasonable straightness formed around a central dowel. The central dowel is comprised of a larger diameter sized wooden rod, the central dowel has two perpendicular slots cut into the horizontal plain starting at the end nearest to the playing or striking end. The multiple rods matching the same length of the central dowel are positioned around the central dowel outside diameter. A retaining sleeve is securely fitted over the gripping end creating a handle area and a small cap may be added for the end of the retainer. At the opposite end, tape is secured around the outer rods slightly back from the playing end allowing some flexibility for the outer rods. An optional retaining sleeve shorter in length is added over the tape. The primary purpose of the slotted central dowel is to increase the rebound of the drumstick design.

An optional movable ‘O’ ring is placed around the outside diameter at the slotted end. This option alters the bounce response and tonal qualities upon striking the intended percussion instrument. The distinguishing features of a slotted central core are to provide substantial rebound. When slots are cut into the end of the central dowel, the slotted wood will compress and then quickly return back to us round shape, this feature of compression and expansion adds significant rebound without resorting to adding synthetic material to the central dowel, such as rubber or foam. It has been realized that most multi-dowel drumstick designs' outer dowels eventually breakdown and soften. Often, percussionist and drummers Will use drumsticks and multi-rod drumsticks beyond their intended dynamic range and while this is often inevitable, the overall integrity of the rebound multi-rod drumstick utilizing the central dowel with slots does absorb a portion of the impact as the slotted area compresses inwards then expands back to its original open slot position, thus adding some longevity via this rebound characteristic. Further, if an outer dowel is compromised and breaks during play the rebound multi-rod can continue to function with 1 or more broken rods unlike foam core models that have been compromised. A central foam core model requires all the rods to be intact to function properly, if an outer rod on a central foam core is broken, the foam merely flops out of its internal position and the drumstick has lost its primary advantage and will not perform as intended. Further, if the drummer percussionist continues to play the drumstick with central foam core, the other dowels will continue to break. The Rebound Multi-Rod Drumstick's playing or striking area is constructed from natural wood, and as such, it follows that its sounds and playability offer more appeal to certain drummers demanding a natural wood timbre and from a percussive perspective. This also increases its natural dynamic range. It has been realized that the larger diameter central dowel twining the full length of the drumsticks has less flexibility and offers familiar stiffer feel of a regular solid wood drumstick over multi-rod drumsticks comprised of all small dowels or similar designs offering a shorter central dowel with foam.

Since the slotted area of the central dowel has the ability to compress and then release it therefore adds significant bounce, this very fast compression and release action can also absorb a significant amount of the impact during playing thus aiding in the protection of the individual rods. The unique features of the slotted central dowel provide the percussionist an easier technical approach when playing musical passages at high tempos and low volume levels. The rigid characteristic of the grip area helps to provide a traditional tactile feel of a drumstick. In addition it allows traditional drum stick techniques such as buzz rolls to be accomplished within traditional sound expectations.

### BRIEF DESCRIPTION OF THE DRAWINGS

In the drawings wherein like numerals are used to depict like parts throughout the same:

FIG. 1 is a side view of the central doubled slotted dowel;

FIG. 2 is an enlarged cross-sectional view along line 2-2 of FIG. 1;

FIG. 3 is a side view depicting the embodiment of the drumstick of the invention;

FIG. 4 is an enlarged cross-sectional view along line 4-4.

FIG. 5 is a side view of the single slotted central dowel;

FIG. 6 is an enlarged cross-sectional view along line 6-6 of FIG. 5;

FIG. 7 is a side view of another embodiment of the drumstick of the invention using alternate smaller diameter single slotted central dowel.

FIG. 8 is an enlarged cross-sectional view along line 8-8 of FIG. 8

FIG. 9 is a side view of the double slotted central dowel;

FIG. 10 is an enlarged cross-sectional view along line 4-4 of FIG. 9;

FIG. 11 is a side view of another embodiment of the drumstick of the invention using 4 slatted bamboo around the central dowel depicted in FIG. 9;

FIG. 12 is an enlarged cross-sectional view along line 12-12 of FIG. 11.

### DESCRIPTION OF THE PREFERRED EMBODIMENTS

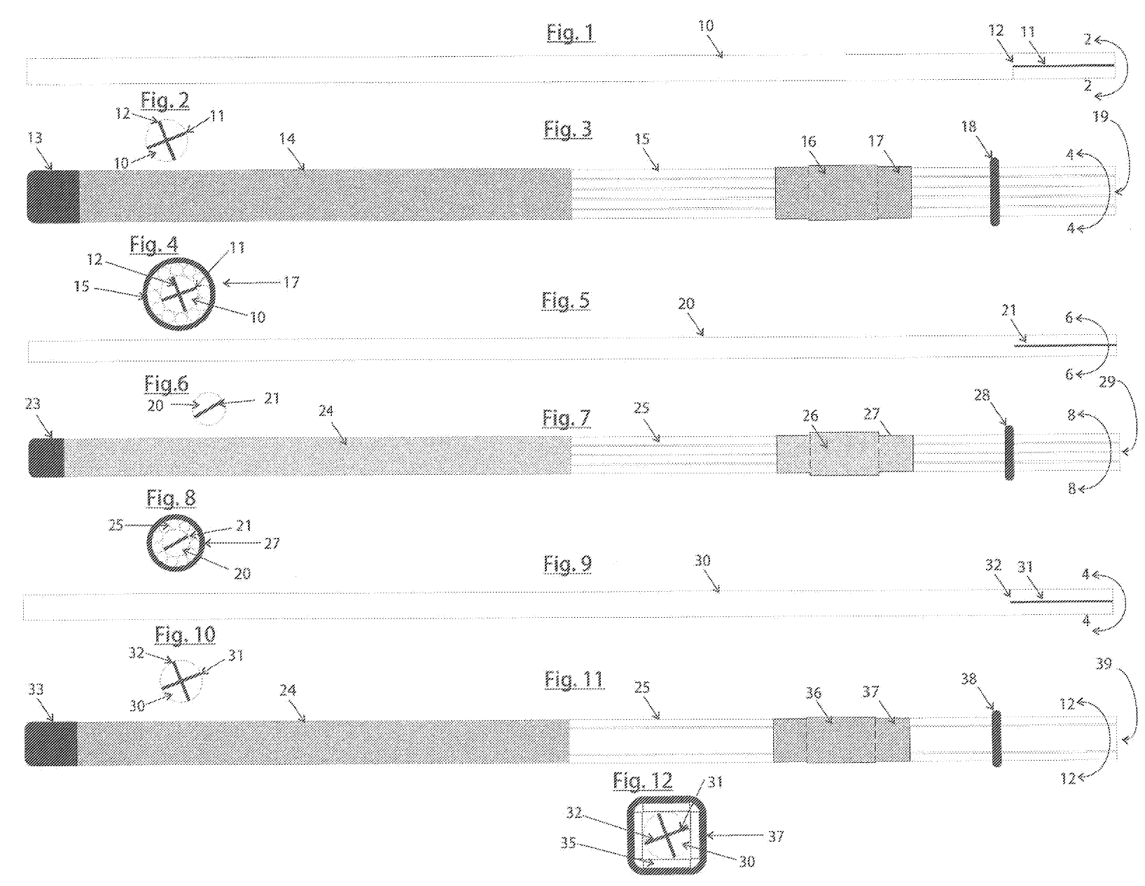

FIG. 1 depicts the central dowel, a dowel 10 with double slotted cuts 11 and 12. Examples of possible woods include birch, oak, maple, ramin and ash, or bamboo, although it is contemplated that others will suffice as well. It has been realized that an optimum depth of the slots is between 1 inch and 2 inches, this creates the most effective compression and release of the slotted wood as if they are too shallow the wood around the slots will not compress inward and if they are too deep the wood will compress but not flex outward in a manner to contribute the maximum rebound. FIG. 2 depicts an enlarged cross-sectional at 2 of FIG. 1 of the central dowel showing the slots 11 and 12 are 90 degree or near to perpendicular angle to each other. FIG. 3 Shows the embodiment of the present design in which the outer rods 15 having a substantially flat planer end surface 19 are bundled tightly around the center dowel 10 with the PVC 14 which becomes the gripping area or handle and at the opposite end, tape 16 is wrapped tightly around the outer dowels at a position that will hold the outer dowels in a secure round position at the playing or striking and far enough back from the horizontal plane at 19 that allow the outer rods some independent movement that contribute to their percussive timbre. A smaller piece of PVC 17 is positioned to hold the outer rods in place near to the slotted end, an end cap 13 is glued onto end the handle 14. An optional ‘O’ ring 18 is shown in this depiction is positioned over 19 and onto the outer rods at the slotted end. It will be appreciated that the individual rods depicted in FIG. 3 of the drumstick invention may be fabricated of any suitable wood or synthetic material such as polypropylene, nylon, PVC or ABS plastics. The particular number of rods 10 used may vary with the application and diameter size of rods 15 used in conjunction with the center rod 10. It has been found, however, that when 12 rods of ⅛ inch diameter are arranged around the ⅜ inch diameter, the result creates an excellent round circumference with minimal gaps between the individual outer rods. FIG. 4 depicts a cross-sectional at 4 of FIG. 3 showing the outer ⅛ inch dowels positioned around the slotted ⅜ slotted central dowel with an optional ‘O’ ring 18.

Another embodiment is depicted in FIG. 5, FIG. 6, FIG. 7 and FIG. 8. In FIG. 5, the central dowel 20 with a single slotted cut 21. Examples of possible woods include birch, oak, maple, ramin and ash or bamboo, although it is contemplated that others will suffice as well. It has been realized that an optimum depth of the slot is between 1 inch and 2 inches as if it is too shallow and the wood around the slot Will not compress inward and if too deep the wood will compress but not flex outward in a manner to contribute the maximum rebound. FIG. 6 depicts an enlarged cross-sectional at 6 of FIG. 5 of the central dowel shaving the slot 21. FIG. 7 shows the embodiment of the present design in which the outer rods 25 having a substantially flat planer end surface 29 are bundled tightly around the center dowel 20 with the PVC 24 which becomes the gripping area or handle and at the opposite end tape 26 is wrapped tightly around the outer dowels at a position that will hold the outer dowels in a secure round position at the playing or striking end and far enough back from the horizontal plain at 29 that allow the outer rods some independent movement that contribute their percussive timbre. A smaller piece of PVC 27 positioned to hold the outer rods in place near to the slotted end, an end cap 23 is glued onto end the handle 24. An optional ‘O’ ring 28 is shown in this depiction is positioned over 29 and onto the outer rods at the slotted end. It will be appreciated that the individual rods depicted in FIG. 7 of the drumstick invention may be fabricated of any suitable wood or synthetic material such as polypropylene, nylon, PVC or ABS plastics. The particular number of rods 20 used may vary with the application and diameter size of rods 20 used in conjunction with the center rod 20. It has been found, however, that when 11 rods of 3/32 inch diameter are arranged around the 5/16 inch diameter, the result creates an excellent round circumference with minimal gaps between the individual outer rods. FIG. 8 depicts a cross-sectional at 8 of FIG. 7 showing the outer 3/32 inch dowels positioned around the slotted 5/16 inch single slotted central dowel with an optional ‘O’ ring 28.

Yet another embodiment is depicted in FIG. 9, FIG. 10, FIG. 11 and FIG. 12. In FIG. 9, the central dowel 30 with double slotted cuts 31 and 22. Examples of possible woods include birch, oak, maple, ramin and ash or bamboo, although it is contemplated that others will suffice as well. It has been realized that an optimum depth of the slot is between 1 inch and 2 inches as if it is too shallow and the wood around the slot will not compress inward and if too deep the wood will compress but not flex outward in a manner to contribute the maximum rebound. FIG. 10 depicts an enlarged cross-sectional at 4 of FIG. 9 of the central dowel showing the slots 31 and 32. FIG. 11 shows the embodiment of the present design in which the outer material consists of 4 bamboo slats 35 having a substantially flat planer end surface 39 are bundled tightly around the center dowel 30 with the PVC 34 Which becomes the gripping area or handle and at the opposite end tape 36 is wrapped tightly around the outer bamboo slats at a position that will hold the outer slats in a secure round position at the playing or striking end and far enough back from the horizontal plain at 39 that allow the outer bamboo slats some independent movement that contribute their percussive timbre. A smaller piece of PVC 37 is positioned to hold the outer bamboo slats in place near to the slotted end, an end cap 33 is glued onto end the handle 34. An optional ‘O’ ring 38 is shown in this depiction is positioned over 39 and onto the outer rods at the slotted end. FIG. 12 depicts a cross-sectional at 12 of FIG. 11 showing the outer bamboo slats positioned around the slotted central dowel with an optional ‘O’ ring 38.

The invention claimed is:

1. A stick type drumstick comprising: a central dowel surrounded by individual outer hardwood rods, said hardwood rods in adjacent parallel formation around the said central dowel form a round bundle; said bundle having two ends and a horizontal axis; first retaining means securing said bundle tightly together in a band-like manner for a relatively short longitudinal span at a location spaced from but closer to the playing end thereof; and second retaining means scenting the said bundles together at the handle end thereof.

2. The drumstick of claim 1 wherein a said central dowel comprised of a wood rod has 2 slots at one of the horizontal axis.

3. The slots in claim 2 are at a perpendicular angle to each other.

4. The slots in claim 2 are cut from the horizontal axis to a depth of 1 inch to 2 inches in depth.

5. The central dowel of claim 2 wherein the said central dowel is a ⅜ inch diameter.

6. The drumstick of claim 1 wherein the diameter of the said individual outer hardwood rods is a ⅛ inch diameter.

7. The drumstick of claim 6 wherein the number of said individual outer hardwood rods is 12.

8. The drumstick of claim 1 wherein further comprising overlay retaining means for binding said bundle together, said overlay retaining means enveloping said bundle and extending from the handle end of the bundle to the point inclusive of the said first retaining means.

9. The drumstick of claim 8 wherein said overlay retaining sleeve means comprises a heat shrinkable sleeve.

10. The drumstick of claim 1 wherein the number of said individual straight rods formed around the said central dowel results in a substantially round cross-sectional shape.

11. The drumstick of claim 1 wherein said hardwood is one selected from the group consisting of birch, maple, ramen, oak or bamboo.

12. The drumstick of claim 1 wherein the playing or striking end of the bundled wooden rods are aligned to form a substantially even surface perpendicular to the longitudinal axis.

13. The drumstick in claim 1 where the first retaining includes an amount of tape.

14. The drumstick of claim 1 wherein the said central dowel is 5/16 inch diameter.

15. The drumstick of claim 14 wherein the diameter of the said outer hardwood rods is ⅛ inch diameter.

16. The drumstick of claim 14 wherein the number of diameter outer hardwood rods is 11.
